(19) United States
(12) Patent Application Publication
(10) Pub. No.: US 2011/0057775 A1
(43) Pub. Date: Mar. 10, 2011

(54) BIOMETRIC AUTHENTICATION DEVICE

(76) Inventors: Il Kweon JOUNG, Gyunggi-do (KR); Bae Kyun Kim, Gyunggi-do (KR); Il Hyung Jung, Seoul (KR); Kyung No Lee, Seoul (KR); Hae Seung Hyun, Gyunggi-do (KR)

(21) Appl. No.: 12/609,333

(22) Filed: Oct. 30, 2009

(30) Foreign Application Priority Data
Sep. 7, 2009 (KR) 10-2009-0084148

(51) Int. Cl. G05B 19/00

(52) U.S. Cl. 340/5.82

(57) ABSTRACT

Disclosed herein is a biometric authentication device. The biometric authentication device includes a main body for forming a hand grip surface and constituting an entire framework of the biometric authentication device. At least one light source is disposed on one side of the main body and configured to radiate light. A reflection unit is included in the main body and attached to a side opposite that of the light source, the reflection unit allowing the radiated light to be incident on a hand and re-reflecting light that is incident on and reflected from the hand. An imaging device is disposed on the side of the main body, which is identical to the side on which the light source is disposed, and is configured to acquire biometric information of the hand by forming images of re-reflected light. An authentication/verification unit performs personal authentication using the biometric information.

### CROSS REFERENCE TO RELATED APPLICATION(S)

This application claims the benefit of Korean Patent Application No. 10-2009-0084148, filed on Sep. 7, 2009, entitled “Biometrics Equipment”, which is hereby incorporated by reference in its entirety into this application.

### BACKGROUND OF THE INVENTION

1. Technical Field

The present invention relates generally to a biometric authentication device, which authenticates an individual by acquiring the biometric information of a hand.

2. Description of the Related Art

Recently, as the importance of personal information has increased, the necessity for biometric authentication technology as methods of protecting information or proving the identity of an individual has rapidly increased.

A typical biometric authentication device is operated as follows. First, a procedure for registering a user is performed, and such a registration procedure is configured such that the biometric authentication device reads the biometric features of the user requesting the registration, extracts features, and stores the features in a database (DB). Further, a verification procedure is configured to compare the biometric features of a user who attempts to access a relevant system, with the features previously stored in the DB and to verify whether the user who attempts to access the system is identical to the registered user.

Currently, features used for such a biometric authentication device may include the face, the voice, hand shape, the iris, veins, fingerprints, etc., and research into individual features has been actively conducted.

In particular, technology for measuring the fingerprint or vein of a finger and performing personal authentication has been most widely used. Further, it is general to adopt a method of performing personal authentication by a separate authentication device and by bringing a finger into contact with a specific location.

As an example of a conventional scheme, a venous image or a fingerprint image of a finger is acquired in such a way as to bring a finger into contact with the sensor unit of an authentication device, illuminate the finger using a light source located below the sensor unit, and extract light reflected from the finger.

However, such a conventional biometric authentication scheme is problematic in that, when it is applied to security systems that are generally used, users must take a separate posture such as by bringing their fingers into contact with the security systems at the time of using the scheme, and thus the time required for biometric authentication increases. In addition, using such a biometric authentication scheme comes along with several disadvantages, such as a separate device having to be added to the system to which the biometric authentication scheme is desired to be applied, and the volume of the system increasing.

Further, in the conventional scheme, it is difficult to acquire various types of and a large amount of biometric information because only the finger, in detail, even several knuckles of the end of the finger, are used. This scheme makes it difficult to sufficiently generate basic data required to identify a plurality of individuals, thus limiting the accuracy of personal authentication.

### SUMMARY OF THE INVENTION

Accordingly, the present invention has been made keeping in mind the above problems occurring in the prior art, and the present invention is intended to provide a biometric authentication device, in which a reflection unit, in particular, a cone-shaped or pyramid-shaped reflection unit, is included in the handle body of a door, so that the handle itself performs the function of a biometric authentication device, thus omitting a separate authentication procedure, and in which biometric information such as the fingerprints, lines and venous patterns of the entire hand, including the palm as well as the fingers, can be acquired, thus improving the reliability of personal authentication.

In accordance with an aspect of the present invention, there is provided a biometric authentication device, comprising a main body configured to form a hand grip surface and constitute an entire framework of the biometric authentication device; at least one light source disposed on one side of the main body and configured to radiate light; a reflection unit included in the main body and attached to a side opposite that of the light source, the reflection unit allowing the radiated light to be incident on a hand and re-reflecting light that is incident on and reflected from the hand; an imaging device disposed on the side of the main body, which is identical to the side on which the light source is disposed, and configured to acquire biometric information of the hand by forming images of the light re-reflected from the reflection unit; and an authentication/verification unit configured to perform personal authentication using the biometric information acquired by the imaging device.

Further, the reflection unit is a mirror.

Further, the reflection unit has a shape of a cone or a pyramid, and is located such that an apex thereof faces the imaging device.

Further, the light source is configured such that a plurality of light sources is disposed around a circumference of the imaging device.

Further, the light radiated from the light source is infrared light.

Further, the light radiated from the light source is visible light.

Further, the main body has a shape of a bar.

Further, the main body has a shape of a light bulb.

In addition, the biometric authentication device further comprises an optical filter disposed between the imaging device and the reflection unit and configured to allow only light having a specific wavelength to pass therethrough.

Furthermore, the optical filter is an infrared light pass filter for allowing only infrared light to pass therethrough.

### BRIEF DESCRIPTION OF THE DRAWINGS

FIG. 1 is a perspective view of a biometric authentication device according to an embodiment of the present invention;

FIG. 2 is a perspective of a biometric authentication device according to another embodiment of the present invention;

FIG. 3 is a sectional view of a biometric authentication device according to an embodiment of the present invention; and

FIG. 4 is a sectional view of a biometric authentication device according to another embodiment of the present invention.

### DESCRIPTION OF THE PREFERRED EMBODIMENTS

Prior to giving the description, the terms and words used in the present specification and claims should not be interpreted as being limited to their typical meaning based on the dictionary definitions thereof, but should be interpreted to have the meaning and concept relevant to the technical spirit of the present invention, on the basis of the principle by which the inventor can suitably define the implications of terms in the way which best describes the invention.

The objects, features and advantages of the present invention will be more clearly understood from the following detailed description and preferred embodiments taken in conjunction with the accompanying drawings. In the present specification, reference now should be made to the drawings, in which the same reference numerals are used throughout the different drawings to designate the same or similar components. Further, in the description of the present invention, if detailed descriptions of related well-known constructions or functions are determined to make the gist of the present invention unclear, the detailed descriptions will be omitted.

Hereinafter, embodiments of the present invention will be described with the attached drawings.

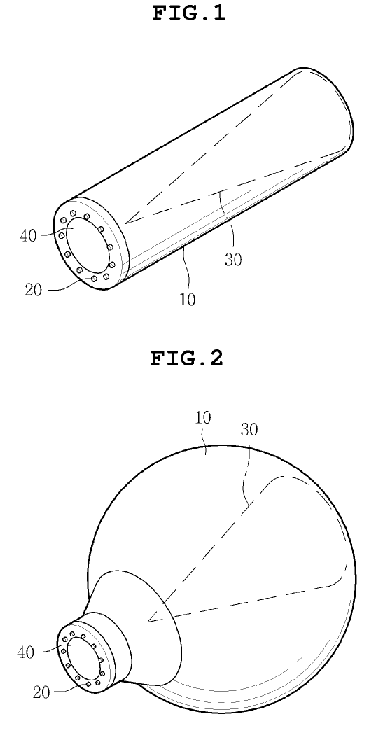

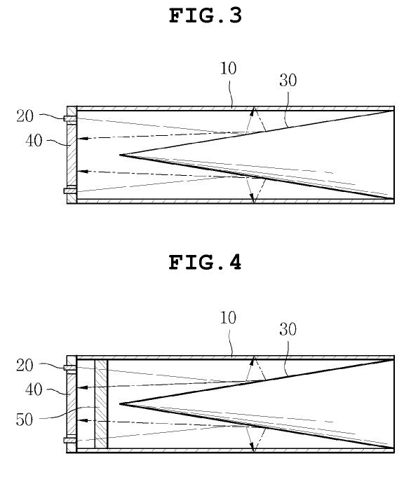

FIGS. 1 and 2 are perspective views of a biometric authentication device according to embodiments of the present invention, and FIGS. 3 and 4 are sectional views of the biometric authentication device according to embodiments of the present invention. The biometric authentication device according to the present invention will be described with reference to FIGS. 1 to 4.

As shown in FIG. 1, the biometric authentication device includes a main body 10, light sources 20 for radiating light, a reflection unit 30 for reflecting light radiated from the light sources, an imaging device 40 for acquiring biometric information from the reflected light, and an authentication/verification unit (not shown) for performing personal authentication using the biometric information acquired by the imaging device 40.

The main body 10 forms a hand grip surface, constitutes the entire framework of the device, and has a hollow inner space to include the components of the biometric authentication device therein.

The main body 10 functions as the grip surface with which the hand comes into contact so as to perform personal authentication, and may have the shape of a typical handle. The main body 10 is preferably made of a material which allows the light radiated from the light sources to be incident on the hand, as described later. For example, a transparent reinforced plastic material may be used as the material of the main body 10.

The main body 10 having the shape of a handle has a hollow inner space and includes therein a plurality of components constituting the biometric authentication device, for example, the light sources 20, the reflection unit 30 and the imaging device 40, which will be described later. The biometric authentication device includes the plurality of components and is merely regarded by the user as only a door handle, thus minimizing aversion to the personal authentication procedure.

In this case, as shown in FIG. 1, the main body 10 preferably has the shape of a bar. The bar-shaped main body 10 may have therein the plurality of components, as described above, and may enable various types of information, such as fingerprints, the lines of the palm and venous patterns, to be acquired because most of the fingers and the palm of the user's hand comes into contact with the surface of the main body 10 when the user's hand grips the main body 10.

Further, as shown in FIG. 2, the main body 10 may have the shape of a light bulb. When the user uses a light bulb-shaped handle, he or she must turn the handle using all five fingers, so that the fingerprints and venous patterns of the five fingers can be accurately acquired.

Since various types of biometric information of the hand are acquired in this way, the reliability of personal authentication can be improved.

The light sources 20 are disposed on one side of the main body 10 and are configured to radiate light, required to acquire the biometric information of the hand, onto the other side of the main body 10. The reflection unit 30 is attached to the other side of the main body 10, as described later.

In this case, the term ‘one side’ means one of the inner surfaces of the main body, and may be preferably located on either of the two sides of the bar in the case of the bar-shaped main body of FIG. 1, or the base of the light bulb in the case of the light bulb-shaped main body of FIG. 2.

Further, the biometric authentication device may have a plurality of light sources 20. In this case, the light sources 20 may be preferably disposed around the circumference of the imaging device 40, which will be described later, as shown in FIGS. 1 and 2. Accordingly, three-dimensional biometric information of the hand can be acquired, and a detailed description thereof is made with reference to the reflection unit 30, which will be described later.

Further, the light sources 20 preferably radiate visible or infrared light. Furthermore, the light sources 20 radiate light in the direction of the reflection unit 30, which will be described later, to acquire the biometric information of the hand. Visible light is used to acquire information about the fingerprints and the lines of the palm, and infrared light is used to acquire information about the venous patterns of the fingers and the palm. Methods of acquiring information about the fingerprints, the lines of the palm, and venous patterns will be described in detail with reference to the imaging device 40, which will be described later.

The reflection unit 30 is included in the above main body 10, is attached to the side opposite that of the light sources 20, and is configured to allow the light radiated from the light sources to be incident on the hand and to re-reflect the light that is incident on and reflected from the hand.

In this case, the reflection unit 30 may be made of a material capable of reflecting the light radiated from the light sources 20. In particular, the reflection unit 30 may be preferably implemented as a mirror to reflect light. Such a mirror is used to easily acquire the biometric information of the hand because its incidence and reflection angles are identical to each other.

Further, the reflection unit 30 is disposed inside the main body, and is preferably located in the main body while being inclined at a predetermined angle in a direction from the other side to one side of the main body. Therefore, a plate-shaped minor may be located in the main body at a predetermined angle in a direction from one side to the other side of the main body. Since the reflection unit 30 must cause the light radiated from the light sources 20 to be incident on the palm, and re-reflect light that is reflected from the palm towards the imaging device 40, which will be described later, one end of the reflection unit 30, located near the imaging device 40, and the other end of the reflection unit 30, located opposite the imaging device 40, must be arranged not to be collinear.

Further, as shown in FIG. 1, the reflection unit 30 has the shape of a cone or a pyramid, the apex of which is preferably provided within the main body to face the imaging device 40, which will be described later. The term ‘pyramid shape’ is the term integrally indicating the shapes of various polygonal pyramids, such as a triangular pyramid and a quadrangular pyramid. However, a portion of the apex does not need to be sharpened, and it is possible to form the portion of the apex in a rounded shape or a cut shape.

Such a cone-shaped or pyramid-shaped reflection unit 30 allows the three-dimensional biometric information of the hand to be acquired. As described above, when light components radiated from the plurality of light sources 20 reach the cone-shaped or pyramid-shaped reflection unit 30, they are individually refracted and incident on the palm or the fingers, enclosing the entire main body 10. Thereafter, light components having biometric information, which have been reflected from the palm or the fingers, are reflected towards the cone-shaped or pyramid-shaped reflection unit 30. The reflection unit 30 re-reflects such reflected light components towards the imaging device 40, which will be described later. Therefore, the biometric authentication device according to the present invention can simultaneously acquire the fingerprints, the lines of the palm and venous patterns of the entire hand.

The imaging device 40 is disposed on the same side as the side on which the light sources 20 are disposed, and is configured to form images of the light components re-reflected from the reflection unit 30, thus acquiring the biometric information of the hand.

In this case, it is preferable that, as shown in FIG. 3, the imaging device 40 be disposed on the same side as the side on which the light sources 20 are disposed, and be surrounded by the light sources 20 and arranged on one side of the main body, as described above.

Further, the imaging device 40 may include a Charge Coupled Device (CCD) or a Complementary Metal-Oxide-Semiconductor (CMOS) sensor, and is configured to form images of the light components re-reflected from the reflection unit. When visible light is incident on the imaging device 40, images of the entire shape of the hand, such as the fingerprints and the lines of the palm, are formed. When infrared light is incident, venous patterns absorb the infrared light, so that portions corresponding to the venous patterns are processed to be darkened, thus forming images of the venous patterns of the fingers and palm.

As shown in FIG. 4, a biometric authentication device according to another embodiment of the present invention may be configured to further include an optical filter 50 disposed between the imaging device 40 and the reflection unit 30 and configured to allow light having a specific wavelength to pass therethrough.

The optical filter 50 is further included, so that the imaging device can acquire only light having a specific wavelength even if typical light sources radiate light, without the above-described light sources radiating light having the specific wavelength (for example, infrared light).

In this case, the optical filter 50 is preferably located in front of the light sources 20 and the imaging device 40 to spatially isolate the reflection unit 30 from the light sources 20 and the imaging device 40. Accordingly, all the light components radiated from the light sources pass through the optical filter 50 and are then incident on the reflection unit 30.

Further, in order for the imaging device to acquire information based on the visible light, the optical filter is preferably implemented as a visible light pass filter. In order to acquire information based on infrared light, the optical filter is preferably implemented as an infrared light pass filter.

Further, the authentication/verification unit (not shown) performs personal authentication using the biometric information acquired by the imaging device 40. The biometric information acquired by the imaging device 40, such as fingerprints, the lines of the palm, and venous patterns, is compared with previously stored authentication patterns, and thus personal authentication is performed. In this case, since the imaging device 40 can acquire information about the fingerprints and the lines of the palm, or venous patterns of the entire hand, depending on the light sources, the authentication/verification unit may also perform personal authentication by comparing only some of the acquired information.

The authentication/verification unit may be configured to include an image processing unit, a pattern storage unit, an authentication unit, a light source driving unit, an imaging device driving unit, and a control unit.

The image processing unit executes predetermined image processing on image data acquired by the imaging device, and outputs the results of the processing to the authentication unit. These components, that is, the image processing unit, and the authentication unit and the control unit, which will be described later, may be implemented using a microcomputer or the like.

The pattern storage unit is a unit for storing authentication patterns (which are patterns to be compared with image patterns captured and acquired at the time of performing authentication, and are obtained by capturing the fingerprints and lines of the palm of the hand or the venous patterns of the hand in advance). The pattern storage unit may be implemented as a non-volatile memory device (for example, Electrically Erasable Programmable Read Only Memory [EEPROM] or the like).

The authentication unit performs personal authentication by comparing the image data output from the image processing unit with previously stored authentication patterns.

The light source driving unit drives the light sources to radiate light, and the imaging device driving unit drives the imaging devices (light reception driving). Further, the control unit controls the operations of the image processing unit, the authentication unit, the light source driving unit and the imaging device driving unit.

Next, the operating process of the biometric authentication device according to the embodiment of the present invention will be described below.

When the hand comes into contact with the external surface of the main body of the biometric authentication device, the light sources are driven by the light source driving unit, and then light components are radiated from the light sources in the direction of the reflection unit.

Further, the light components radiated from the light sources are incident on and refracted from the reflection unit, and are then radiated onto the hand. The light components radiated onto the hand are reflected from the hand and are incident again on the reflection unit. The reflection unit re-reflects the light components towards the imaging device.

In this case, since light components are simultaneously radiated from the light sources disposed around the circumference of the imaging device, and are incident on and refracted from the cone-shaped or pyramid-shaped reflection unit, the light components are radiated onto the entire hand placed on the main body. Accordingly, the imaging device can acquire all the biometric information of the entire hand.

Further, after suitable imaging processing has been executed by the image processing unit on the images acquired by the imaging device, the processed images are input to the authentication unit.

Thereafter, the authentication unit performs personal authentication by comparing the processed images with the authentication patterns for authentication stored in the pattern storage unit.

Therefore, the results of the final authentication (authentication result data Dout) are output, and thus the processing of authentication is completed.

As described above, the present invention is advantageous in that, since a separate authentication action is not required, the time required for personal authentication is shortened.

Further, the present invention is advantageous in that, since the handle itself of a door functions as an authentication device, the system of the present invention adopts the format of an authentication system of which a person is unaware, thus decreasing aversion to a personal authentication procedure.

Furthermore, the present invention is advantageous in that it can acquire three-dimensional biometric information, such as the fingerprints, the lines of the palm, and venous patterns of the entire hand, from various regions, thus improving the reliability of personal authentication.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A biometric authentication device, comprising:
a main body configured to form a hand grip surface and constitute an entire framework of the biometric authentication device;
at least one light source disposed on one side of the main body and configured to radiate light;
a reflection unit included in the main body and attached to a side opposite that of the light source, the reflection unit allowing the radiated light to be incident on a hand and re-reflecting light that is incident on and reflected from the hand;
an imaging device disposed on the side of the main body, which is identical to the side on which the light source is disposed, and configured to acquire biometric information of the hand by forming images of the light re-reflected from the reflection unit; and
an authentication/verification unit configured to perform personal authentication using the biometric information acquired by the imaging device.

2. The biometric authentication device as set forth in claim 1, wherein the reflection unit is a mirror.

3. The biometric authentication device as set forth in claim 1, wherein the reflection unit has a shape of a cone or a pyramid, and is located such that an apex thereof faces the imaging device.

4. The biometric authentication device as set forth in claim 1, wherein the light source is configured such that a plurality of light sources is disposed around a circumference of the imaging device.

5. The biometric authentication device as set forth in claim 1, wherein the light radiated from the light source is infrared light.

6. The biometric authentication device as set forth in claim 1, wherein the light radiated from the light source is visible light.

7. The biometric authentication device as set forth in claim 1, wherein the main body has a shape of a bar.

8. The biometric authentication device as set forth in claim 1, wherein the main body has a shape of a light bulb.

9. The biometric authentication device as set forth in claim 1, further comprising an optical filter disposed between the imaging device and the reflection unit and configured to allow only light having a specific wavelength to pass therethrough.

10. The biometric authentication device as set forth in claim 9, wherein the optical filter is an infrared light pass filter for allowing only infrared light to pass therethrough.
